(19) United States
(12) Patent Application Publication
(10) Pub. No.: US 2008/0126417 A1
(43) Pub. Date: May 29, 2008

(54) Systems and methods for emergency services, medical and community response to critical incidents

(76) Inventor: Laurel Anne Mazurik, Toronto (CA)

Correspondence Address: BIRCH STEWART KOLASCH & BIRCH, PO BOX 747, FALLS CHURCH, VA, 22040-0747, US

(21) Appl. No.: 11/798,137

(22) Filed: May 10, 2007

Related U.S. Application Data
(60) Provisional application No. 60/799,323, filed on May 11, 2006.

(51) Int. Cl. G06F 17/30

(52) U.S. Cl. 707/104.1; 707/E17.005

(57) ABSTRACT

Systems and methods consistent with some embodiments of the present invention provide for managing a plurality of records, including storing a plurality of records, wherein each of the plurality of records includes at least one of a section and subsection; receiving a request to access one of the plurality of records, wherein the request includes identification information identifying information about a user requesting access; determining the level of access of each of the at least one section and subsection associated with the one of the plurality of records requested; selecting at least one of the section and subsection of one of the plurality of records based on the identification information of the user and the determined level of access; providing access to at least one of the selected section and subsection in a record; wherein the record may be simultaneously accessed by a plurality of users, and wherein information for updating at least one of the section and subsection in the record may be received simultaneously by a plurality of users.

### RELATED APPLICATIONS

This application is related to and claims priority to Provisional Application No. 60/799,323 filed May 11, 2006, entitled “Systems and methods for emergency services, medical and community response to critical incidents,” which is expressly incorporated herein by reference in its entirety.

### BACKGROUND OF THE INVENTION

1. Field of the Invention

The present invention relates generally to systems and methods for operating in a mass casualty incident, and more specifically to systems and methods that enable information providers/users operating in a mass casualty incident to be able to communicate through a central system and further to view, enter and modify information in real time.

2. Description of the Related Art

When a mass casualty incident occurs, members of police, fire and rescue, emergency medical personnel, governmental entities, etc., may respond. However, each of these groups of responders have their own individual systems to operate. Communication between groups is usually limited to voice communication using, for example, radios. When too many people are using the radio, it is difficult to provide and access information between the groups and also between members in the same group, because of the “chatter” on the line. Further, because the different groups use different systems to store information, it is very difficult to share or access and update information from other groups in real time.

As such, there is a need for a system that enables users operating in a mass casualty incident to be able to communicate through a central system and further to view, enter and modify information in real time.

### SUMMARY

Systems and methods consistent with some embodiments of the present invention provide for managing a plurality of records, including storing a plurality of records, wherein each of the plurality of records includes at least one of a section and subsection; receiving a request to access one of the plurality of records, wherein the request includes identification information about a user requesting access; determining the level of access of each of the at least one section and/or subsection associated with the one of the plurality of records requested; selecting at least one of the section and/or subsection of one of the plurality of records based on the identification information of the user and the determined level of access; providing access to at least one of the selected section and/or subsection in a record; wherein the record may be simultaneously accessed by a plurality of users, and wherein information for updating at least one of the plurality of sections an/or subsections in a record may be received simultaneously by a plurality of users.

Alternatively a system, consistent with some embodiments of the present invention provides for managing information including a receiver for receiving information from a plurality of networks; storage device for storing the received information in a plurality of records, the plurality of records including at least one section and subsection; and a management device for accessing information related to at least one of the plurality of records and providing the accessed information based on a security level of a user requesting the information, wherein at least one section and/or subsection of at least one of the plurality of records may be simultaneously accessed by a plurality of users, and wherein information for updating at least one of the section and subsection in the record may be received simultaneously by a plurality of users.

### DRAWINGS

The accompanying drawings, which are incorporated in and constitute a part of this specification, illustrate embodiments of he invention and, together with the description, explain the principles consistent with the embodiments of the present invention. In the drawings:

FIG. 1 depicts an exemplary system environment for implementing features consistent with embodiments of the present invention;

FIG. 2 depicts an exemplary diagram of components of some components operating within the system environment, consistent with embodiments of the present invention;

FIG. 3 depicts an exemplary diagram of components of a server consistent with embodiments of the present invention;

FIG. 4A depicts exemplary organization of a community information system consistent with the principles of some embodiments of the present invention;

FIG. 4B depicts exemplary community information display consistent with the principles of some embodiments of the present invention;

FIG. 4C depicts exemplary hospital display consistent with the principles of some embodiments of the present invention;

FIG. 4D depicts exemplary personal information display consistent with the principles of some embodiments of the present invention;

FIG. 5 depicts an exemplary flow diagram of the steps performed by the server, consistent with some embodiments of the present invention; and

FIG. 6 depicts an exemplary flow diagram of the steps performed by the server, consistent with some embodiments of the present invention.

### DETAILED DESCRIPTION

Systems and methods consistent with principles of some embodiments of the present invention provide for obtaining information during an incident, storing information related to the incident, and enabling streamlined access to the stored information. Systems and methods consistent with principles of some embodiments of the present invention further provides for enabling efficient synchronous and asynchronous communication between users of the system.

While some of the detailed description herein is directed to a mass casualty incident, it may be appreciated that systems and methods discussed herein may be utilized in non-mass casualty incidents, in the normal operation of hospitals, in the normal operation of city, state and/or government offices, etc.

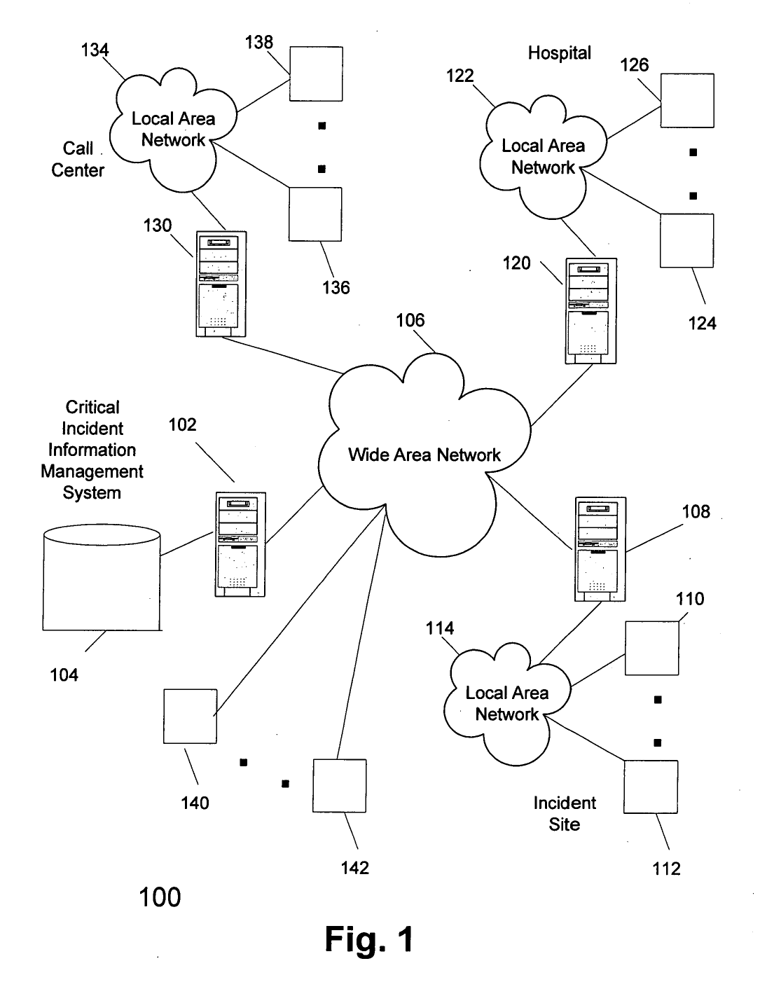

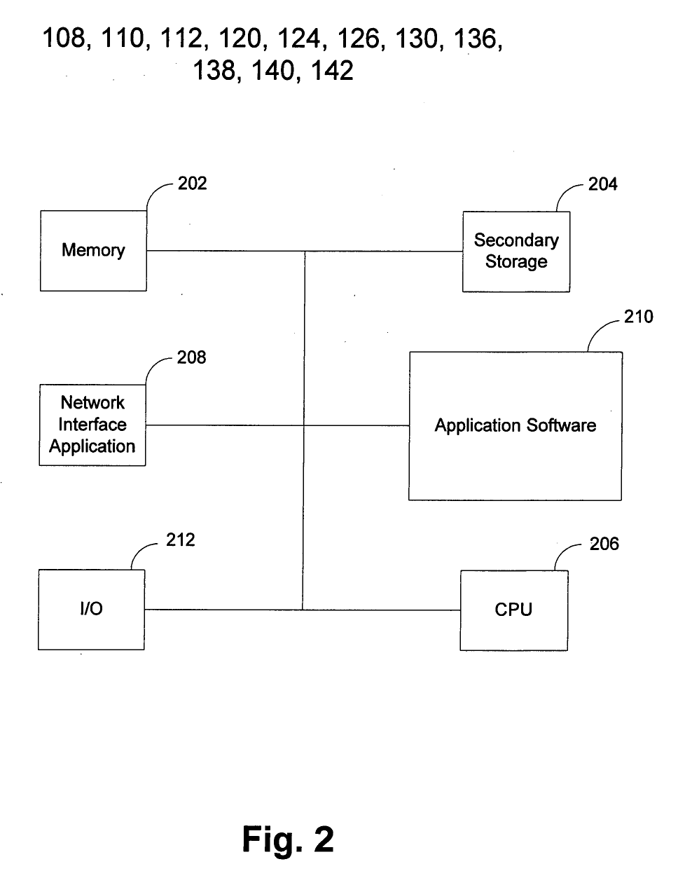

The accompanying drawings, which are incorporated in and constitute part of this specification, illustrate embodiments of the invention and, together with the description, explain the principles of the invention. In the drawings, FIG. 1 is an exemplary system environment for implementing the features consistent with some embodiments of the present invention; and FIG. 2 is an exemplary diagram of the components of computing devices, consistent with principles of the present invention.

System Architecture

FIG. 1 is an exemplary diagram of system environment 100 for implementing principles consistent with some embodiments of the present invention. The components of system 100 may be implemented through any suitable combination of hardware, software and/or firmware. As shown in FIG. 1, system 100 includes wireless access point 108 communicably linked to portable computing devices 110, 112 through network 114. Portable computing devices 110, 112 may be implemented as a personal digital assistant (PDA), portable computing tablet, or any other portable computing device that enables a user to communicate text, images, and/or voice through network 114. Network 114 may be implemented as NL 911, a wide area network for use by the police department, fire department, emergency medical services, etc. Portable computing devices 110, 112 may access server 102, which is communicably linked to central information repository database 104 through network 106. Network 106 may be implemented as CA*net 4, a robust, dedicated high bandwidth network.

Central information repository database 104 may store all information collected from users of system 100. Users of the system may access all data or a subset of data from database 104 depending on their security clearance. Database 104 may be communicably linked to wide area network 106 through web server 102. Certain users within environment 100 may have the ability to add/move/update/view information stored in database 104 as discussed herein. Incorrect data may be removed from view but archived in non-priority access storage along with the corrections. This creates a means for information acquisition process to be reviewed at a later date, if required. More than one instance of central information repository database 104 may be located within and communicably linked to system 100.

Call Center 128 may include a plurality of computing devices. Computing devices 130, 136, 138 may communicate with each other using local area network 134 and may further access database 104 through wide area network 106. Portable computing devices 136, 138 may be implemented as any computing device capable of communicating with server 130, for example, portable computing tablet, personal computer, or any other portable computing device that enables a user to access data from database 104 through network 106.

Hospital 118 may include a plurality of computing devices Computing devices 120, 124, 126 may communicate with each other using local area network 122 and may further access database 104 through wide area network 106. Portable computing devices 124, 126 may be implemented as any computing device capably of communicating with server 120, for example, personal digital assistant, portable computing tablet, personal computer, or any other portable computing device that enables a user to access database 104 to store and access data.

Computing devices 140, 142 represent a plurality of computing devices on network 106. While only two computing devices are depicted, more than two computing devices may be communicably linked to network 106. Further, although computing devices 140, 142 are depicted as personal computing devices, these personal computing devices may be implemented as a plurality of computing devices operating on network, either local or wide area network, public or private, and are more fully discussed below.

FIG. 2 depicts an exemplary block diagram of components included in devices residing within system 100. As depicted in FIG. 2, computing devices may include memory 202, secondary storage 204, central processing unit 206, network application(s) 208, software applications 210 and input/output devices 212. It may be appreciated that the specifications of these components, and the network and software applications may vary based on the network(s) the individual devices communicate in as discussed herein and based on the software applications the devices operate as discussed herein.

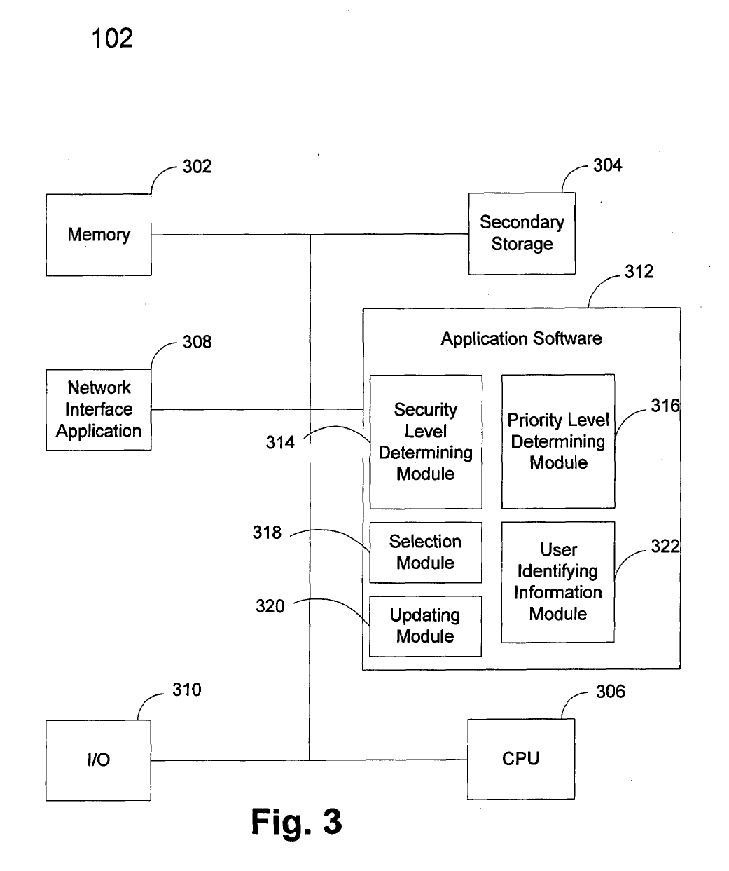

FIG. 3 depicts an exemplary block diagram of components included in device 102 residing within system 100. As depicted in FIG. 3, computing device 102 may include memory 302, secondary storage 304, central processing unit 306, network application(s) 308, input/output devices 312 and software application(s) 314. Software application(s) 314 may include security level determining module 314 for determining security levels assigned to each of a plurality of sections and/or subsections associated with a patient's health care record; priority level determining module 316 for determining priority associated with each of the plurality of sections and/or subsections associated with one of a plurality of patients' health care record; selection module 318 for selecting at least one a plurality of sections and/or subsections associated with a patient's health care record based on security level and priority level; updating module 320 for updating at least one section and/or subsection associated with a patient's health care record when information for updating the at least one section and/or subsection is received from more than one user or information provider; and user identifying information module 322 for accessing and providing data based on user identifying information.

It may be appreciated that the specifications of these components, and the network and software applications may vary based on the network(s) the individual devices communicate in as discussed herein and based on the software applications the devices operate as discussed herein.

Incident Overview

Once an incident occurs, it is important to obtain information as quickly as possible so that the proper authorities can assess the situation and respond accordingly. The process may start by receiving information that a mass casualty incident has occurred. This information may be received through a 911 emergency call. Upon receipt of the notification that an incident occurred, police, fire, and/or emergency medical services (EMS) may be dispatched to the scene of the incident. The NL 911 System for mass casualties can be activated by any member in a 911 Call Center based on information provided by the caller. This information must be confirmed and deemed reliable by the call taker, regardless of the source. The source may include cell phone calls from witnesses at the incident, confirmed multiple witness calls, media reports, first responders on-scene, etc.

The definition of the number of individuals involved required to be call a “mass casualty” incident of disaster proportions may be defined by each local or region and dependant on the resources available. A disaster is simply defined as an incident that exceeds the capacity of responders to manage it.

Once it is determined that a mass casualty incident has occurred, the initial first responders Police, Fire and EMS may establish a Joint Incident Command at the Scene. Upon activation of NL 911, the 911 Call Centre may dispatch a Field Data Team (FDT) to the incident site, and alerts may be transmitted to Unified Command members, including police, fire, EMS, hospitals, government and support agencies, civic notification groups and/or media. They may be directed to log on or call into the NL 911 System and view the preliminary information. While the FDT is en route and unified command prepare to log or call in, 911 Call Centre may open Critical Incident Information Management System which consists of a reserve of communication pathways and data storage space in the CIR with the capacity to absorb a sudden surge in communication and information processing demand. They may also alert regional, national and/or international 911 Call centers to track this information from the FDT.

The Field Data Team (FDT) may be a part of a Special Operations Team with members from EMS, Fire and Police and may include mobile network specialists. Each member is tasked with acquiring specific data and/or establishing the technical capacity to transmit the incident information to the NL 911 System. Simultaneously, the Unified Command Members may convene through the NL System and form a virtual emergency operations center. Each member may have access to the information limited by, or based on, their security clearance, i.e. police issues may not be viewed by media unless a media alerts is necessary to prevent further loss of life or property.

Upon reviewing the data in NL 911 the Unified Command members may if appropriate, declare a disaster. Upon declaring a disaster, a NL 911 Critical Incident Information Management System (CIIMS), represented as system 100 in FIG. 1, may be activated. CIIMS provides a secure system that enables users of system 100 to obtain and access data efficiently.

Once CIIMS is activated, it may alert the Incident Management System (IMS) personnel of each unified command member: police, fire, EMS, hospitals, government and support agencies, civic notification groups, and media, and direct them to use CIIMS. Stakeholder IMS personnel may selectively analyze the CIIMS data obtained by the Field Data Team and the information provided by the Unified Command as it applies to the tasks they must carry out and determine what resources need to be deployed to respond to the disaster. Further Stakeholder IMS personnel may receive specific requests from their front line personnel, including police, fire, EMS, hospitals, government and support agencies, civic notification groups and media. These requests are analyzed and, if appropriate, resources may be deployed based upon the requests. The resources include wireless and/or on-line consultations with experts anywhere in the world.

CIIMS enables users to input and access data real-time. Each of the police, fire, EMS, hospitals, government and support agencies, civic notification groups and media, have the ability to enter and/or access certain data at a central data repository and generates alerts that may be directed to certain users of the system.

First Responders

First responders may be those members of police, fire, and EMS that respond to a 911 call that an incident has occurred. The first responders assess the incident and establish a joint incident command. The joint incident command seeks to unify the efforts of the three different services and provide a central source of on-site incident information. Specialty response teams such as CBRN (chemical, biological, radiation or nuclear), tactical (weapons, explosives), heavy urban search and rescue etc teams if present may also form part of the Joint Incident Command. Joint Incident Command may make requests through the NL 911 critical incident management system (CIIMS) for additional resources. For example, if an unexploded bomb needs to be disarmed, JIC may submit a request to the Police Incident Management personnel to identify and obtain access to a bomb expert to help disarm the bomb. In another example, if sarin gas was released in a subway, Joint Incident Command may submit a request to Fire and EMS incident management personnel to identify and obtain access to experts in sarin gas, access to stockpiled antidotes, etc.

Field Data Team

The field data team includes a team of personnel that each has a specific function. The team may include members from the Police Department, Fire Department and Emergency Medical Services Department. Certain members of the team may be designated as mobile network specialists. The mobile network specialists, upon arriving at the incident site, establish a network and a link to NL 911 network. The network 114 may be a local area network that enables the team and other users at the incident site to communicate with each other, with wide area network 106, and with database 104. Additionally, mobile network specialists may further erect wireless cameras that are capable of receiving and transmitting image data through network 114 to web server 102 for viewing and storage at database 104.

Network 114 may be erected around the incident site to enable the field data team, and other users at the incident site to communicate with devices on network 106. Network 114 may be erected, for example, wireless, portable, self-configuring, battery-powered, mobile wireless mesh repeaters/routers capable of instantly establishing meshed 802.11b or similar wireless networks. Devices including laptops, PDAs, wireless cameras, VoIP (voice-over-IP) phones, digital radios, sensors, etc., may operate within network 114.

The mobile access points may communicate through network 106 through satellite to transmit and receive information including communication with web server 102 and database 104. Alternatively, network 114 may be established using conventional wired network technology or combinations of wired and wireless.

Other members of the team may be designated as data mission specialists. The data mission specialists may be equipped with wearable portable computing devices 110, 112. Portable computing devices 110, 112 provide voice, text and image transmission capabilities. Portable computing devices 110, 112 may alternatively be implemented as known handheld computing devices.

Certain other members of the Field Data Team may have assigned functions to obtain accurate data to enable other authorities to assess the incident and determine what additional steps need to be taken. For example, each team member may have a specific data mission, i.e., a series of information sets or “packets” that they must gather in priority. It may be reflective of the team members professional association, for example, EMS may provide casualty information, fire may provide hazards related to fire or chemicals, police may provide security information, etc. Some of these sets may be “tagged” with preset transmission destinations in the database i.e. to ALL, which is all organizations in unified command or SELECTED, which is one or a combination of organizations or services such as police or to fire or EMS or Hospitals only etc. All of the data obtained by the Field Data Team may be entered into database 104. Each “packet” of information is designated a priority for collection and/or transmission: for example, if possible Priority 1 must be reviewed or collected immediately, Priority 2, within the hour, Priority 3 within 8 hours, Priority 4 24-72 hours and priority 5>72 hours. All data received can have its priority designation reclassified by the receiver, who may chose to secondarily share the information internally within their organization or another group. All or part of the data obtained by the Field Data Team may be accessible for viewing by police, fire, EMS, hospitals, governmental and support agencies, civic notification groups and media, depending on their security clearance.

Unified Command

Unified Command may be a command group operating virtually and may include members that have been pre-assigned. In disasters the membership would include first responders police, fire, emergency medical services, allied health through hospitals, government, non-government support organizations, civic notification systems, and media. Depending on the scale of the disaster unified command members from several geographic distributions may be called e.g. municipal, regional, national and international. Using portable computing devices, they communicate with each other by text, voice, video, etc., and view the preliminary data obtained by the Field Data Team. Based on the preliminary data, Unified Command may determine the incident is a disaster situation. Upon declaration of a disaster, the NL 911 activates the Critical Incident Information Management System (CIIMS). All members monitor information gathered through the Field Data Team, Joint Incident Command hospitals and other sources and work together to identify additional regional, national or international resources are needed in order to properly respond to the incident. If resource needs exceed local capacity, the appropriate geographic area that is capable of supplying the necessary resources is contacted using system 100 and, asked to provide the assistance,

Incident Management System (IMS)

IMS includes an Incident Management Team which are specially trained personnel that analyze the information contained within the CIIMS. This information may come from multiple sources including the Field Data Team, the Joint Incident and Unified Command. Each member of the CIIMS Police, Fire, EMS, Hospitals, Government, NGO's, civic notification and media may have an Incident Management Team. This allows them to mobilize their own internal resources and identify what components they have that could be utilized. This information may be entered into the CIIMS where the unified command may then galvanize the components into a single coordinated incident response. Each Incident management team may also simultaneously monitor and respond to internal requests for assistance. Incident Management Team members may include an: Incident Commander or Manager, Liaison, Occupational Health and Safety, Logistics, Planning, Operations, Finances, etc and all resources under each of these members command. IM Team personnel may operate remotely from the incident site and review data as it is obtained from the Field Data Team, Unified Command, etc. Each internal IMS Team may activate and manage their own disaster plan, including staff call backs, resource mobilization, etc and may request or offer resources to Unified Command. Local Unified Command may be required to seek additional resources from other geographic regions. Doing this may require the activation of larger unified command systems, e.g. regional, national, and/or international.

Central Information Repository

The central information repository may be used to collect, store and display information in the form of:

Personal Information Records

Community Information Records

Persons entering the information into the Central Information Repository database may be called an information provider (IP), and each will have a unique identifier such as password, fingerprint, voice, retinal scan, bar codes, pass cards, etc. that is contained within their personal information record (PIR).

Each Information Provider's access will be restricted to the areas they can “view or read-only”, and/or “read-write”,

For example a personal physician caring for the individual may have access to all of their health records, where as a hospital registration clerk may have access to information limited to patient demographics such as name, date of birth etc. A police officer may be granted a “view only” look at a criminal record but would not be allowed to view the medical record, except for possibly emergency information that may appear on a common medic alert bracelet, such as allergies.

An individual may have access to all of their personal information record but may only be allowed to “read-write” selected areas, for example contact information or place of residence, and read-only areas such as sections of their health record, where a physician was the information provider.

Each time an IP accesses the system, the time, location on the system i.e. records viewed or data entered may be logged in their personal identification record.

A Personal Information Record (PIR) includes of all of the information relating to the individual that may be stored in the e-record. Information stored in e-records may belong to the individual and to the agencies granted permission to enter information. Examples of the information stored in database 104 may include personal statistics, i.e., date of birth, address, etc., health care information, i.e., allergies, etc., government records, i.e., driver's license information, driving record, record of convictions, etc. This information may form the foundation of personal identification systems used to identify an individual.

The PIR may allow the individual to automatically register for services with the agencies supporting it. Registration may be done, for example, through a PIR card with a magnetic stripe, bar code, wi-fi or RFID, password, fingerprint scan, etc. The individual may have access to all of their personal information record but may only be allowed to “read-write” selected areas, for example contact information or place of residence.

A Community Information Record is organized much like a telephone directory with services displayed by organization and/or category, and geographic location or distribution.

A community may be virtual or real, consisting of a geographic location and/or persons and/or organizations who are connected by an agreement to respond to the information. The number of persons and or organizations may range from 1-infinity.

In a Community Information System, Fire, Police, EMS, and Public Health may for example maintain information related to public safety, such as notify individuals of infectious disease outbreaks, security risks, etc.

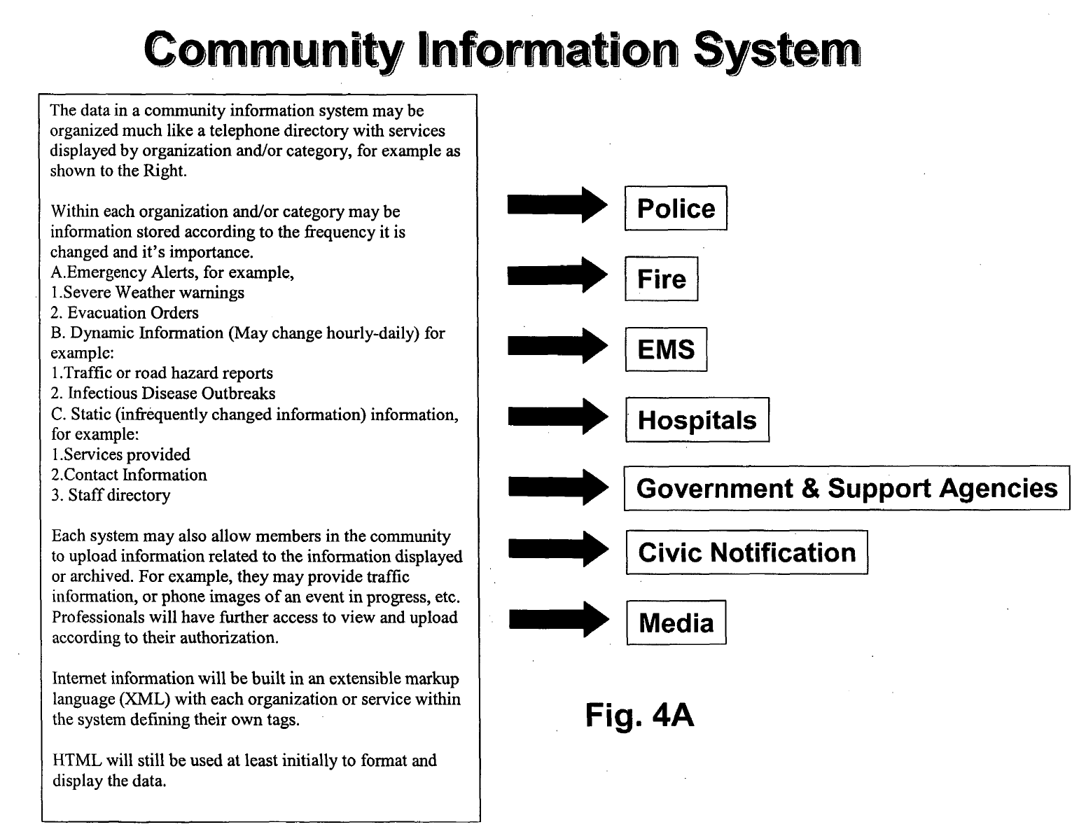

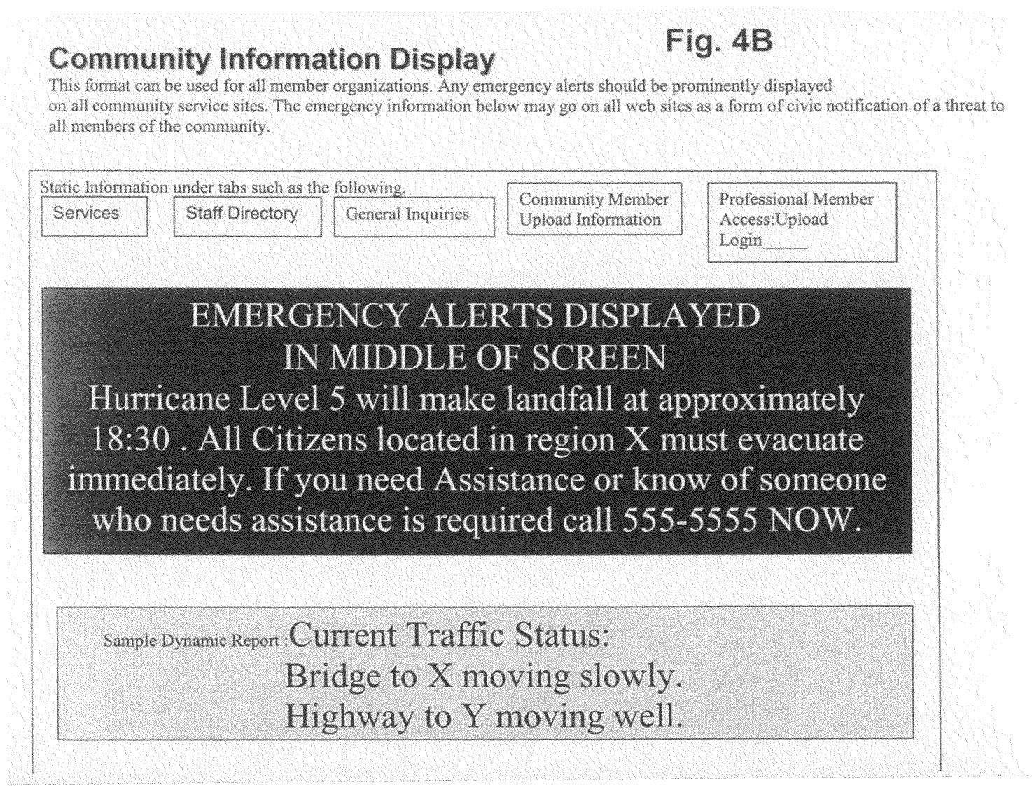

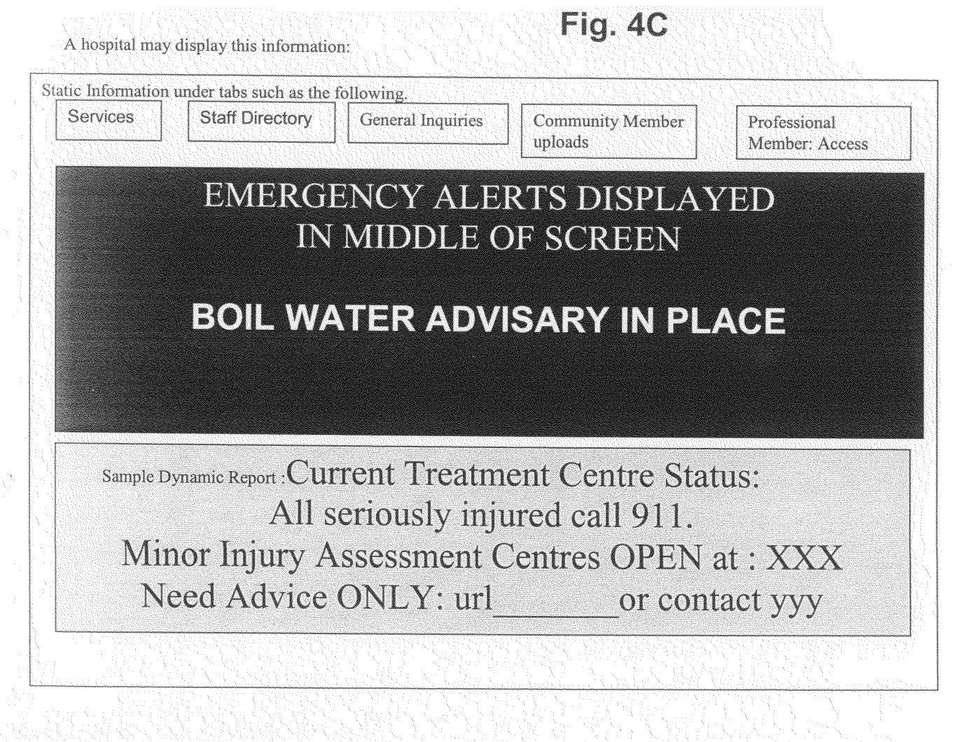

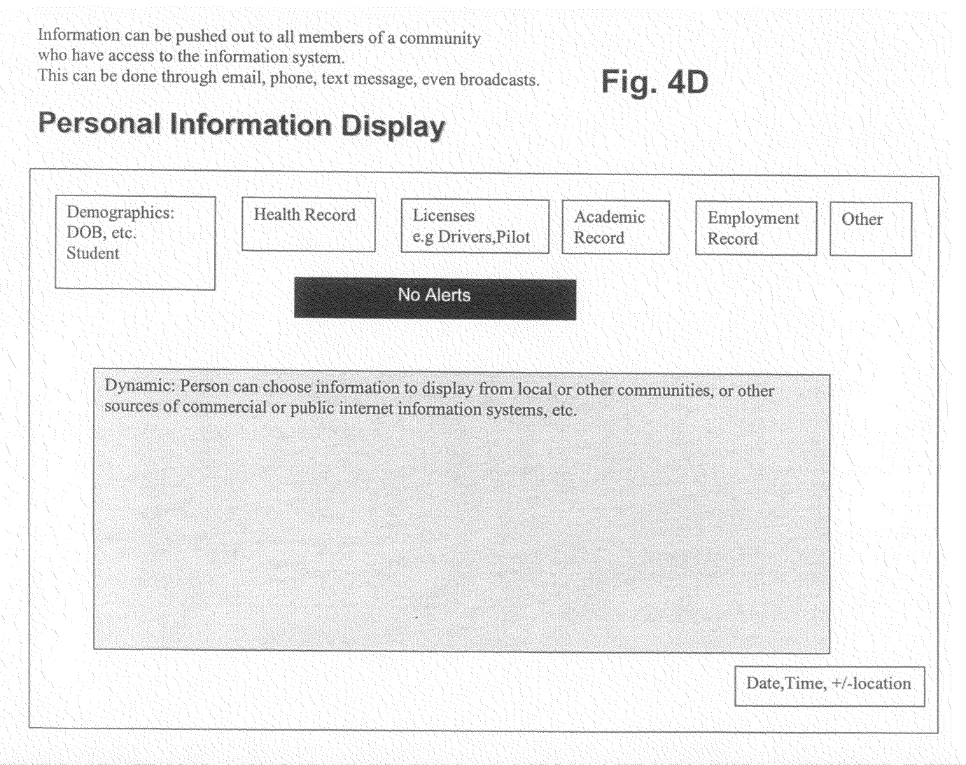

FIG. 4A depicts exemplary organization of a community information system consistent with the principles of some embodiments of the present invention. FIG. 4A includes a description of the type of information or services that are available on a screen that a user can access where each of the services contributes information to an emergency display. FIG. 4A includes an exemplary description of an index may be organized.

FIG. 4B depicts exemplary community information display consistent with the principles of some embodiments of the present invention. The display depicted in FIG. 4B may be used within the police department, public health department, etc. In mass casualty event, all users may have the same display. FIG. 4B shows an exemplary display that may be used by police. The boxes entitled services, staff directories, general inquiries, community member uploads and professional member access: upload login are all selectable. Upon selection of one of these buttons, additional information may appear on the display screen. This information may be accessed from database 104. Further, the community member uploads enable a user to input information for storage at database 104. As shown in FIG. 4B, the middle of the display includes emergency alerts that have been pushed to the device. The lower portion of the display includes dynamic reports which may include selectable reports, i.e., traffic etc.

FIG. 4C depicts exemplary hospital display consistent with the principles of some embodiments of the present invention. The display includes elements similar to those elements discussed in FIG. 4B, including selectable buttons, the alert area and the dynamic reporting area, wherein a hospital employee, i.e., nurse, doctor, etc., may utilize this display.

FIG. 4D depicts exemplary personal information display consistent with the principles of some embodiments of the present invention. The display shown in FIG. 4D depicts an exemplary display screen that may be viewed by a user accessing information regarding an individual. Upon accessing this display, a user may access an individual's record stored in database 104. The selectable buttons depicted in the top portion of the display enable a user to access section(s) and/or subsection(s) of an individual's record.

All records are made of sections and subsections. These are “packets” of information which may be displayed or requested. Each packet is encapsulated or isolated so that only one may be displayed at a time. Packet Isolation or encapsulation allows multiple users to provide information on a single record, simultaneously, by working on separate packets. Once a packet is completed, it is accessed for data re-entry only if correction or updating is required.

“Continuous record building” is a feature of this system where multiple information providers simply build on and or corrects the previous entries and or add new information only.

Under certain conditions more than one opinion may be required to move towards agreement on the information contained with a packet, this “Consultative Data Entry.” In this situation multiple Information Providers can simultaneously view a single packet of information, to reach a consensus on interpretation. For example, if one radiologist wants the opinion of a second radiologist about an x-ray, they may both view the image simultaneously and through discussion (phone, text, face to face, other) each may enter their opinions and the final consensus (if reached) into the packet. In situations of rarely encountered or complex events this process may require multiple inputs, all of which may be recorded, so the process of agreement can be tracked.

Alternatively, this may done asynchronously, if a decision is not required immediately. For example the first radiologist may need additional help or consultation in definitely reaching a final interpretation of an image. The radiologist may request a consultation be sent and a deadline for a response set. In this situation, the section and/or subsection of a record that stores the radiologists' opinions may be associated with a particular time period. The information stored in the packet may show the preliminary interpretation, request for additional input, and the final interpretation. If the radiologists input their opinions within the associated time period, then both opinions may be stored. If the inputs are not provided within the associated time period, then neither of the inputs may be stored in the section and/or subsection of the record. The option will be available to display only the final interpretation and archive the process by which it was achieved. It may be appreciated that inputs from more than two users may be required in order to enter data in the record, section and/or subsection.

Within each organization and/or category may be information stored according to the frequency it is changed and its importance.

The information may be built in an extensible markup language (XML) with each organization or service within the system defining their own tags.

HTML may be used at least initially to format and display the data.

During an emergency database 104 may have the ability to adapt to demand by closing and opening access points, channels and or circuits according to demand by using multiple internet networks to form a grid system for communication infrastructure support.

This may be engineered through Internet based user controlled light paths and service oriented architecture. Multiple Internet based networks, can be integrated through contractual agreements to form a geographic grid to support a global network.

This creates the capacity to absorb surges of demand for communication pathways, by diverting demand from over utilized systems to underutilized systems. In general in order to have surge capacity, ˜10% of the total capacity should be in reserve. In a global network, time zone utilization patterns can efficiently create the reserve; as in geographic areas when people are sleeping those networks may be have a low rate of use.

If a surge in demand for information pathways arises overloading a specific area the non-essential calls or information processing demands may be diverted to underutilized networks, to preserve as much local capacity as possible to support CIIMS.

CIIMS may be used to maintain all data that is obtained from and provide access to all the users of system 100, including the Field Data Team, Unified Command, members of police, fire, EMS, hospitals, government and support agencies, civic notification groups and media. Multiple instances of database 104 may be located throughout system 100, wherein each instance of the database 104 includes the same data. All information including personal information records, information providers, information distribution pattern, etc., may be stored in secure, redundant, information repositories multiple access points through Internet. Updates made to a database 104 in one location prompts the same updates to all other instances of database 104. Database 104 is configured to arrange information by time, location, priority etc., and enable searches by priority information, or by specific information, etc. Database 104 further has the capacity to connect the individuals in communities and distribute information as required. Database 104 is capable of being mined for statistical analysis while preserving personal privacy.

All data being communicated on CIIMS may be stored at database 104. All data entered/accessed into database 104 is time stamped and further identifies the party that entered/accessed the information.

Database 104 may further sort, select, and store information in priority sequence. Data mining software may detect key packets of information and push out programmed responses. Database 104, in combination with web server 102, may include functionality such that when certain information is entered by one user of system 100, an alert may be generated and forward to a different user of system 100. For example, upon the Unified Command declaring a disaster, an alert may be generated to certain members of each of the police, fire, EMS, hospitals, government and support agencies, civic notification groups and/or media advising of the declaration of the disaster. The “destination” pathways of the information and “distribution pattern” reflects the “community” of persons who may be affected by the information. The destination choice for the information is ALL members of a specific community or SELECTED. For example: Community: Florida, Surrounding states, and US Disaster response agencies. ALL: i.e., including citizens of Florida: Hurricane inbound. Will hit land in 20 hours. Evacuation indicated.

SELECTED: All municipal responders, and hospitals in Florida Areas most likely to be affected: to activate disaster plans.

Applying the Concepts to a Critical Incident involving a Community:

911 is called:

Male Student Shooter on Campus Building X, 4^{th} Floor; Gunfire Heard

Police, Fire and EMS dispatched to scene:

Each may begin their own sections within the Critical Incident Information Management System but may be able to view selected screens from each other, that contain information that affects their joint safety, security or health.

Police, Fire and EMS may have specific data missions and may transmit this information to the central information repository where experts from police, fire and EMS in a unified command position may review the collective information and assemble a situational awareness report for the Critical Incident. This situational awareness report may begin a Joint Critical Incident Record, which may document the events as they unfold.

e.g. 09:05 am 911 Call. Gunshots Heard School X

09:15-09:20 am based on several reports including additional 911 calls and phone transmitted images from students, they are able to identify the shooter as John Dnyŝ̂ currently located in classroom B floor 3. Armed with a Automatic Rifle.

This classroom normally has 30 students inside plus a teacher.

09:30 Maps from security demonstrate access from stairways 4-5-6-7.

09:35 Estimated number shots fired 45. Number injured not confirmed.

Based on this information Orders may be given to special operations teams and their support members, about actions to take.

Hospitals and other support agencies may be notified of details as they apply to their need to prepare a response to the event.

CIIMS May Support Mass Casualty Field and Hospital Based e-Triage

All Casualties involved in a mass casualty incident should be triaged i.e. sorted according to their medical care needs.

The personnel performing the triage in the field or hospital may use the universal Respiration, Pulse, Mentation (RPM) status or similar system to assign a color code to an individual patient. The color code for mass casualty triage is universal: Red—immediate treatment, Yellow-Urgent (within an hour) Green-non-urgent (deferrable for hours) Black-deceased. The patient may have with a color-coded Triage Tag, attached to them. All patients are then be sorted for transport according to their color code, i.e. Reds ahead of yellows ahead of green ahead of black. As they are loaded into a transport vehicle a Triage Officer(s) or Paramedic Transporting the patient may enter the following Priority 1 information into a Tablet (portable wireless computer) with a touch screen menu: Age or Age Range; Sex; Injury or Illness; Triage Color; and Destination and estimated Time of Arrival (ETA) and transmit to the CIR.

The Triage Officer May Begin the Patient Encounter Record

Section 1: May 8,2007 09:20 am
20 yr old male.
Gunshot wound L Chest.
Unconscious.
RED
Destination: Hospital X
ETA: 10 minutes
Encounter number 1.

This information may additionally be is entered an RFID or wi-fi chip or bar code label etc, may be affixed to the patient's triage tag. This information contained within the Tag may be used to track the patient. The triage officer or paramedic may scan the tag to show time of departure from scene. The tablet may automatically transmit patient information to the database 104. Database 104, and server 102 may generate an alert and forward the triage information to the receiving hospitals to hospital personnel may see the list of casualties inbound to them, their injuries, acuity, estimated time of arrival, etc. thus giving them the opportunity to accurately prepare the resources required to treat the inbound casualties.

Paramedics transporting the patient may enter as much information en route into the patients' personal information record as they are able under the conditions, for example, they may have to devote time to caring for the patient as a priority over entering information.

If the patient has an Identifier e.g., health card it may be scanned using a PDA with a reader to open their PIR Health Record.

This may reveal:

Section 1: Demographics
Name, date of birth, address, phone number,
Photo. Next of Kin contact information
PIR: Identifier98\hat{ }%&#11
Section 2. Health Record Summary
Allergies: Penicillin
Medications: Salbutamol
Past Medical History: Asthma

If the patient is unidentified as in this example an emergency record may be generated with a new identifier assigned to the casualty.

Section 1: May 8,2007 9:23 am
Patient assigned to :Paramedic Crew 123
Initial Assessment:
20 yr old male.
Gunshot wound L Chest.
Unconscious.
RED
Destination: Hospital X
ETA: 10 minutes
Encounter number 1. PIR: Identifier98\hat{ }%&#11

The paramedics, en route may enter additional information as able. For example:

Section 2: May 8,2007 09:28
Paramedic Crew En Route Event Summary :
Vital Signs: P 140 BP Carotid only RR 40
Absent Breath Sounds L.
Needle decompression L Chest initiated
Repeat Vitals: BP 90/60 R 30 P 130
ETA. 5 minutes.
Encounter number 1. PIR: Identifier98\hat{ }%&#11

When the patient arrives at their destination the receiving Triage Nurse may scan the tag to show the patient has arrived. Any information gathered electronically by the paramedic may appear in the e-health record for this encounter. The patient may be automatically registered if the paramedic was able to gather the information and/or had the patient's health card.

A hospital Patient ID Bracelet with an identifier device such as RFID, wi-fi ID, bar code, etc may be affixed to the patient or they can continue to use the pre-hospital identifier device and input hospital data. All staff actively involved in the patient's care may now access their chart, by simply scanning the patient's ID band.

In the hospital, the patient Encounter record may continue to be built and repeat or additional information packet requests or displays may “pop up” up the hospital's patient record display system. For example: For the hospital Registration Clerk the information uploaded on arrival may be displayed as follows.

Time: 10:03 Date: May 8,2007
Crew: 123

ARRIVAL to Hospital X:

Information Uploaded into Hospital Patient Registry:
Clerk: JKB4

Encounter number 1. PIR: Identifier98\hat{ }%&#11

UNIDENTIFIED MALE 20

For the Triage Nurse:

Time: 10:03 Date: May 8,2007
Triage RN: JN\hat{ }&F4
Initial Paramedic Assessment & Event Summary
Reviewed: Yes
Current Patient Assessment:
Combative. P 140 BP 80/50 R 40 Decreased AE L.
Triage Acuity or Priority: 1
Destination in ED: Trauma Bed 1.
Call Physician to see? YES
Encounter number 1. PIR: Identifier98\hat{ }%&#11
Time: 10:09 Date: May 8,2007
Trauma Bed 1 RN: KVUU%$1
Patient Assessment:
Decreased LOC. Carotid Only . 150 Absent BS. L.
RR40
Plan: Additional nurses called for.
Monitors, IV, 02
Physician Present: Yes
Encounter number 1. PIR: Identifier98\hat{ }%&#11
Time: 10:09 Date: May 8,2007
Trauma Bed 1 MD: 887#@1
Patient Assessment:
Findings confirmed:
Action: Chest tube placed L chest. Drained 500cc
blood
FAST Performed: Negative
Cross Match Blood Ordered.
Labs Ordered:
XRAYS Ordered.
Surgical Consult Requested: 10:15
Encounter number 1. PIR: Identifier98\hat{ }%&#11

A Consultative Information Packet can be generated: For example two surgeons and anesthetist may discuss the best surgical treatment for this patient.

JOINT CONSULT:Time: 10:30 Date: May 8,2007
Trauma Bed 1
Trauma Surgeon MD: 952#@
Thoracic Surgeon MD: 789\hat{ }#
Anesthesia MD: 999&%#
Patient Assessment:
Findings confirmed:
Action: Chest tube placed L chest. Drained 500cc
blood
FAST Performed: Negative
Cross Match Blood Ordered.
Labs Ordered:
XRAYS CT Scan Chest: Ruptured Bronchus,
Extensive air leak
Joint Consult: 10:30-40
Anesthesia: Intubate R lung & prepare for OR.
Thoracic Surgeon will perform Operative Repair.
Encounter number 1. PIR: Identifier98\hat{ }%&#11

All Health care providers may enter in sequence the information required to reflect the patient condition and actions taken to support them. Each may have their own section in which to enter information but may be able to view the information being gathered by others. This prevents redundant information entry and allows more time to be dedicated to patient care instead. For example, the nurse may focus on gathering vitals such as pulse, and blood pressure, etc. The physician can view this and make decisions based on this information. Others may also begin to populate the record with information as they gather it, for example, lab tests may be added by lab technicians, etc. If in viewing information gathered by others it is found to be in error, then a correction may be recorded. For example if no allergies are not known initially but at a later time medic alert is found indicating the patient has an allergy this information can be added.

As information is entered into the patient record, built in software may continue to “mine” the data and change the Triage Acuity Indicator, e.g. color or number that reflects the speed at which patient care is required. An Alert may notify the staff of any change in status.

Additional Triage systems may be provided for Critical Care and Surgical Care Treatment, under mass casualty incident conditions and under normal operating conditions.

Call Center

Call center 128 may be used to receive and process calls relating to the incident. These calls may be received from citizens looking for information about the incident, friends or family members that may have been injured during the incident, locations of heath care facilities, advice for themselves if they were involved, etc. Call center 128 may be physically remote from the incident site. Call center 128 may include a plurality of personal computing devices 136, 138 communicably linked to network 134. Network 134 may be implemented as a local area network or a wide area network. Operators using personal computing devices 136, 138 may be centrally located or may be physically located remote from each other. Operators may receive incoming queries by telephone, electronic mail, instant messaging, etc. The incoming queries, prior to being received at personal computing devices 136, 138 may be filtered and processed at server 130 depending upon the type of request and the priority of the request. If you dial a general number or URL you may get a menu to choose from i.e. press 1 for police etc., or an operator or leave a message. You may get asked key questions i.e. what is the nature of the request, if it is “an emergency” then this may receive a higher priority in terms of analysis by a call centre member and a response, e.g. if the caller is describing an emergency the call may be forwarded to 911

Upon receipt of a query, the operator of computing device 136, 138 may access database 104 to obtain information relating to the query. For example, if a citizen is looking to find if their husband was injured, the citizen may contact call center 128. The call may be forwarded to an operator at computing device 136 to process. The operator may receive the query and access database 104 to determine if the husband is entered in the database and what, if any, information may be associated with the husband. The operator may determine that the husband is at a certain health care facility and may provide the information to the citizen that called.

By providing the call center remote from the incident site, and by providing the call center access to certain information stored at database 104, information regarding the incident may be disseminated in an orderly and timely manner.

System Operation

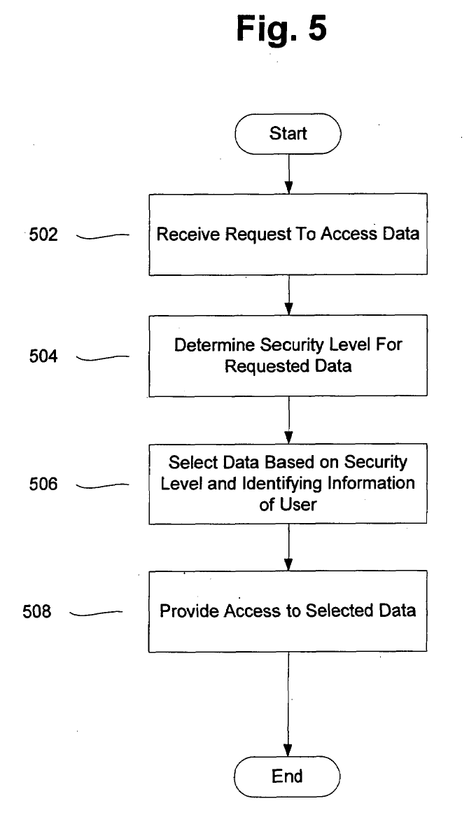

FIG. 5 depicts an exemplary flow diagram of the steps performed by the server in managing information. During a mass casualty incident, an information provider may wish to access, view and/or update information stored in database 104. Using the personal computing device, i.e., 110, the information provider may access his dashboard to request information regarding a particular individual. The information provider may enter identifying information into the personal computing device 110 via, i.e., swiping a personal identification card through a bar code reader, providing biometric information, providing a password, etc. The information provider may then request access to an injured individual's e-record. The request, including the information provider's identifying information, may be transmitted from the personal computing device 110 through network 114, received at server 108 and transmitted to server 102. Upon receipt (Step 502), server 102 accesses the e-record of the injured individual and determines the security level required to access each of the records, sections and/or subsections of information associated with the injured individual's e-record (Step 504). Server 102 then determines what sections or subsections of information the information provider is qualified or permitted to view based on the security information associated with the information provider (Step 506). Sever 102 may then select those sections and/or subsections that the information provider is permitted to have access to. Server 102 may then access priority information associated with each of the selected sections and/or subsections. Sections and/or subsections with higher priorities may be selected for transmission first, while sections and/or subsections with lower priorities may be transmitted only after information is provided for sections and/or subsections with the higher priorities.

Server 102 may then select a minimum number of sections or subsections to transmit to the personal computing device 110 of the information provider. For example, up to seven sections at a time that have the highest priority and have the appropriate security level may be transmitted to the personal computing device 110 of the information provider for access/entry/modification, etc. (Step 508).

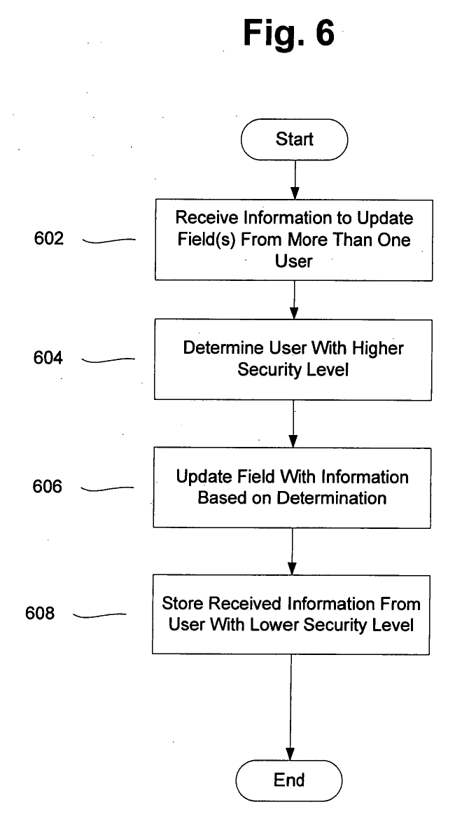

As noted above, information may be simultaneously accessed by more than one user/information provider. FIG. 6 depicts an exemplary flow diagram of the steps performed by the server in managing information received by more than one user. Server 102 may provide information regarding an individual's e-record to more than one information provider. The requests for the access are as set forth in FIG. 4. Server 102 may further receive information to update a section and/or subsection of an e-record from more than one information provider (Step 602). In this instance, server 102 determines the security level of each of the information providers seeking to update the information (Step 604). Server then updates the section and/or subsection with the information from the information provider with the highest security level (Step 606). The information received from the information provider with the lower security level may be stored for later viewing and processing (Step 608).

It may be appreciated by one skilled in the art that the system described herein is not limited to mass casualty incidents and may be implemented for day to day operations. Modifications and adaptations of the invention may be apparent to those skilled in the art from consideration of the specification and practice of the invention disclosed herein. It is intended that the specification and examples be considered as exemplary only, with a true scope and spirit of the invention being indicated by the following claims.

Personal Computing Devices

Personal or portable computing devices or computing devices discussed herein may include a user interface, or dashboard, that allows the user to streamline the data entry process. Each type of user may have a different user interface depending on the type of data they are responsible for obtaining. For example, the members of the Field Data Team may use a user interface that incorporates selectable screens identifying the information they are responsible for collecting. A member of the fire department on the Field Data Team may view a user interface that incorporates screens identifying the location of a fire, the size of the fire, the estimated number of casualties of the fire, etc. However, a paramedic may view a different dashboard that incorporates elements related to patient care. For example, the paramedic's dashboard may enable selection and data entry relating to access to an electronic patient chart, including the data discussed above. Each of the dashboards may be created with a limited number of graphic selectable elements per screen in order to minimize confusion in user operation.

I claim:

1. A method for managing a plurality of records, comprising:
storing a plurality of records, wherein each of the plurality of records includes at least one of a section and subsection;
receiving a request to access one of the plurality of records, wherein the request includes identification information identifying information about a user requesting access;
determining the level of access of each of the at least one section and subsection associated with the one of the plurality of records requested;
selecting at least one of the section and subsection of one of the plurality of records based on the identification information of the user and the determined level of access;
providing access to at least one of the selected section and subsection in a record;
wherein the record may be simultaneously accessed by a plurality of users, and
wherein information for updating at least one of the section and subsection in the record may be received simultaneously by a plurality of users.

2. The method of claim 1, wherein information is provided to the user based on priority information associated with the identifying information of the user.

3. The method of claim 1, wherein providing access to the at least one of the selected section and subsection in the record further comprises:
determining priority of each of the selected at least one section and subsection; and
displaying a minimum number of selected at least one section and subsection based on the determined priority, thereby providing access to the minimum number of at least one section and subsection to the user.

4. The method of claim 3, further comprising:
determining that the user has provided information for the minimum number of at least one section and subsection; and
displaying an additional minimum number of at least one section and subsection based on the determined priority, thereby providing access to the additional number of at least one section and subsection to the user.

5. The method of claim 1, wherein information that is related to a patient's health is stored.

6. The method of claim 1, wherein information for updating the at least one section and subsection in the record may be received simultaneously by a plurality of users further comprises:
receiving information for updating at least one section and subsection of one of the plurality of patient's health care records from more than one user;
storing the received information from more than one user;
determining the security level of each of the more than one user; and
updating the at least one section and subsection with the received information from the user that has the highest security level.

7. The method of claim 1, further comprising:
associating with the at least one section and subsection a period of time in which information may be received by at least two users;
receiving information from at least two users for updating the at least one section and subsection within the associated period of time; and
updating the at least one section and subsection with information received from the at least two users when it is determined that the two users have been in direction communication with each other or when it is determined that the at least two users have consulted when the at least one section and subsection requires consultative data entry.

8. An apparatus for managing a plurality of records, comprising:
a memory storing a set of instructions; and
a processor for executing the stored set of instructions to perform a method for managing a plurality of records, the method comprising:
storing a plurality of records, wherein each of the plurality of records includes at least one of a section and subsection;
receiving a request to access one of the plurality of records, wherein the request includes identification information identifying information about a user requesting access;
determining the level of access of each of the at least one section and subsection associated with the one of the plurality of records requested;
selecting at least one of the section and subsection of one of the plurality of records based on the identification information of the user and the determined level of access;
providing access to at least one of the selected section and subsection in a record;
wherein the record may be simultaneously accessed by a plurality of users, and
wherein information for updating at least one of the section and subsection in the record may be received simultaneously by a plurality of users.

9. The apparatus of claim 8, wherein information is provided to the user based on priority information associated with the identifying information of the user.

10. The apparatus of claim 8, wherein providing access to the at least one of the selected section and subsection in the record further comprises:
determining priority of each of the selected at least one section and subsection; and
displaying a minimum number of selected at least one section and subsection based on the determined priority, thereby providing access to the minimum number of at least one section and subsection to the user.

11. The apparatus of claim 10, further comprising:
determining that the user has provided information for the minimum number of at least one section and subsection; and
displaying an additional minimum number of at least one section and subsection based on the determined priority, thereby providing access to the additional number of at least one section and subsection to the user.

12. The apparatus of claim 8, wherein information that is related to a patient's health is stored.

13. The apparatus of claim 8, wherein information for updating the at least one section and subsection in the record may be received simultaneously by a plurality of users further comprises:
receiving information for updating at least one section and subsection of one of the plurality of patient's health care records from more than one user;
storing the received information from more than one user;
determining the security level of each of the more than one user; and
updating the at least one section and subsection with the received information from the user that has the highest security level.

14. The apparatus of claim 8, further comprising:
associating with the at least one section and subsection a period of time in which information may be received by at least two users;
receiving information from at least two users for updating the at least one section and subsection within the associated period of time; and
updating the at least one section and subsection with information received from the at least two users when it is determined that the two users have been in direction communication with each other or when it is determined that the at least two users have consulted when the at least one section and subsection requires consultative data entry.

15. A computer-readable medium, storing a set of instructions, executed by a processor, for managing a plurality of records, the method comprising:
storing a plurality of records, wherein each of the plurality of records includes at least one of a section and subsection;
receiving a request to access one of the plurality of records, wherein the request includes identification information identifying information about a user requesting access;
determining the level of access of each of the at least one section and subsection associated with the one of the plurality of records requested;
selecting at least one of the section and subsection of one of the plurality of records based on the identification information of the user and the determined level of access;
providing access to at least one of the selected section and subsection in a record;
wherein the record may be simultaneously accessed by a plurality of users, and
wherein information for updating at least one of the section and subsection in the record may be received simultaneously by a plurality of users.

16. The method of claim 15, wherein information is provided to the user based on priority information associated with the identifying information of the user.

17. The method of claim 15, wherein providing access to the at least one of the selected section and subsection in the record further comprises:
determining priority of each of the selected at least one section and subsection; and
displaying a minimum number of selected at least one section and subsection based on the determined priority, thereby providing access to the minimum number of at least one section and subsection to the user.

18. The method of claim 18, further comprising:
determining that the user has provided information for the minimum number of at least one section and subsection; and
displaying an additional minimum number of at least one section and subsection based on the determined priority, thereby providing access to the additional number of at least one section and subsection to the user.

19. The method of claim 15, wherein information that is related to a patient's health is stored.

20. The method of claim 15, wherein information for updating the at least one section and subsection in the record may be received simultaneously by a plurality of users further comprises:
receiving information for updating at least one section and subsection of one of the plurality of patient's health care records from more than one user;
storing the received information from more than one user;
determining the security level of each of the more than one user; and
updating the at least one section and subsection with the received information from the user that has the highest security level.

21. The method of claim 15, further comprising:
associating with the at least one section and subsection a period of time in which information may be received by at least two users;
receiving information from at least two users for updating the at least one section and subsection within the associated period of time; and
updating the at least one section and subsection with information received from the at least two users when it is determined that the two users have been in direct communication with each other or when it is determined that the at least two users have consulted when the at least one section and subsection requires consultative data entry.

22. A system for managing information comprising:
a receiver for receiving information from a plurality of networks;
storage device for storing the received information in a plurality of records, the plurality of records including at least one section and subsection; and
a management device for accessing information related to at least one of the plurality of records and providing the accessed information based on a security level of a user requesting the information,
wherein at least one section and subsection of at least one of the plurality of records may be simultaneously accessed by a plurality of users, and
wherein information for updating at least one of the section and subsection in the record may be received simultaneously by a plurality of users.

23. The system of claim 22, wherein
at least one section and subsection of a record is associated with a period of time in which information may be received by at least two users and,
wherein information received from at least two users is received within the associated period of time the at least one section and subsection is updated with information received from the at least two users when it is determined that the two users have been in direction communication with each other.
